(19) United States
(12) Patent Application Publication
(10) Pub. No.: US 2012/0112420 A1
(43) Pub. Date: May 10, 2012

(54) GASKET HAVING A WAVE STOPPER

(76) Inventors: Jürgen Stetter, Idstein (DE); Jan Müller, Betzdorf (DE); Andreas Hans Vulpius, Riedstadt (DE)

(21) Appl. No.: 13/201,695

(22) PCT Filed: Oct. 27, 2009
(86) PCT No.: PCT/EP2009/007678

§ 371 Date: Oct. 25, 2011

(30) Foreign Application Priority Data
Feb. 16, 2009 (DE) 10 2009 009 169.6

(51) Int. Cl. F02F 11/00; B21D 37/00

(52) U.S. Cl. 277/593; 72/462

(57) ABSTRACT

The invention pertains to a metallic flat gasket with at least one metallic layer, wherein the metallic gasket features at least one sealing area and a compression limiting area that is realized in the form of a corrugated profile in at least one layer of the metallic gasket, wherein the corrugated profile is formed in the area of the compression limiter by several corrugations that extend on concentric circular lines. At least one first corrugation extends along at least one predetermined arc of a circle and does not extend in at least one predetermined sector of a circle. The flat gasket features at least one second interrupted corrugation that extends concentric to the first corrugation, has a different radius than the first corrugation and extends at least in the sector of a circle, in which the first corrugation does not extend, and does not extend in at least one sector of a circle, in which the first corrugation extends.

The present invention pertains to gaskets with stoppers or deformation limiters, respectively. The present invention furthermore pertains to gaskets with corrugated stoppers or deformation limiters, respectively. The present invention particularly pertains to metal gaskets. The present invention also pertains to metallic flat gaskets. The present invention furthermore pertains to metallic cylinder head gaskets.

Various flat gaskets with different stoppers are already known from the state of the art.

Document DE 10219526 A1 pertains to a metal gasket with a stopper layer that is realized in the form of a chessboard-like embossing in a layer of the metal gasket.

Document US 2004/0160017 A1 pertains to a metal gasket with a stopper layer that is realized in the form of a honeycomb-shaped embossing in a layer of the metal gasket.

Unexamined and first publication DE 10 2004 061 964 A1 pertains to a gasket with a stopper layer that is realized similar to a ring segment, wherein the individual ring segments are realized in the form of separate layers.

A corrugated deformation limiter realized in the form of a corrugated embossing in a metal layer is known from Document DE 102 066 047 424.

The corrugated deformation limiter known from document DE 20 121 984 is realized in the form of a corrugated embossing in a metal layer and referred to as “corrugated stopper” in this document.

It is also known that corrugated stoppers not only can be realized in the form of a corrugated sheet, wherein these corrugations of a corrugated stopper can also be impressed or embossed into a sheet in the form of a thickness profile such that a stopper profile is created, in which profile valleys and profile peaks are respectively arranged at the same locations on the front side and the rear side.

Until now, the stopper layers extended around obstacles such as, for example, bolt holes or combustion chamber convexities, e.g., pre-combustion chambers of diesel engines, such that the manufacturing costs, particularly for a tool for manufacturing metallic flat gaskets, were very high.

The present invention is based on the objective of lowering the expenditures for the manufacture of a metallic flat gasket with a corrugated stopper.

It would furthermore be desirable to reduce the manufacturing costs for impressing/embossing tools for metallic flat gaskets, particularly for flat gaskets with constrictions such as, e.g., valve pockets and through-holes in the area of a compression limiter that may realized in the form of a stopper or a corrugated stopper.

According to an embodiment of the present invention, a metallic flat gasket with at least one metallic layer is proposed. In this case, the metallic gasket comprises at least one sealing area and one compression limiting area. The compression limiting area is realized in the form of a corrugated profile in at least one layer of the metallic gasket. The corrugated profile is realized in the area of the compression limiter by means of several corrugations that extend along concentric circular lines.

In this case, at least a first corrugation extends along at least one arc of a circle, is not closed and does not extend in at least one predetermined sector of a circle.

The flat gasket comprises at least one second corrugation that is not closed and extends concentric to the first corrugation. The second, open corrugation has a different radius than the first corrugation. The second corrugation extends at least in the sector of a circle, in which the first corrugation does not extend. The second corrugation does not extend in at least one predetermined sector of a circle, in which the first corrugation extends.

In this case, the first and the second corrugation (at least partially) supplement one another on different radii of the gasket in order to achieve a uniform compression limiting function over the entire area of the compression limiter.

In the present invention, the gasket may comprise several sealing areas and several compression limiting areas. In the present invention, the sealing area may encompass the compression limiting area. In the present invention, the sealing area may also be surrounded by the compression limiting area.

In one exemplary embodiment, the metallic flat gasket furthermore comprises at least one through-opening that is enclosed by the sealing area and the compression limiting area. The through-opening may represent, for example, part of a combustion chamber of a thermal engine.

It is also proposed to utilize the flat gasket for sealing a chamber that is filled with a fluid such as oil or gas or for sealing a vacuum. The through-opening is not required for the inventive effect of the inventive gasket because the gasket also may merely serve as a seal for an opening.

In this case, a gasket without through-opening may, if applicable, produce a superior seal because only one sealing surface needs to be sealed.

In another exemplary embodiment of the present invention, the through-opening is provided with convexities and the area of the compression limiter is indented. In this embodiment, at least one corrugation is interrupted in the area of the compression limiter at the (at least one) indentation, but this (at least one) missing corrugation is once again compensated by (at least one) additional outer corrugation arranged on the compression limiter. It is therefore prevented that the function of the compression limiter is impaired due to narrower areas.

In another embodiment, the metallic flat gasket features through-holes in the area of the compression limiter. The through-holes interrupt the corrugations that concentrically extend in the area of the compression limiter such that the function of the compression limiter is impaired in this area. In this embodiment, this impairment is compensated, according to the invention, with additional corrugations arranged in the area of the through-holes.

In another embodiment of the present invention, essentially the same number of corrugations always extend around the center of the through-opening to be sealed in a circular or arc-shaped fashion, namely radially from this center. Consequently, the effective area of the compression limiter essentially always has the same width regardless of the fact whether or not recesses in the gasket are situated in the region of the compression limiter. Since the number of corrugations is always an integral number, “essentially identical” means a deviation from a maximum of one.

In another exemplary embodiment of the present invention, the first and the second corrugation overlap in a sector by at least half the width of the compression limiting area. This makes it possible to realize the outside contour and the inside contour of the compression limiting area in a more uniform fashion such that edges can be prevented.

In another embodiment of the metallic flat gasket, the height of the corrugations gradually decreases on their ends. As in the above-described instance, this makes it possible to prevent load peaks on the edge of the compression limiter.

In another embodiment, the corrugations are formed by beads in the at least one metallic layer. In this case, the compression limiter is realized in the form of a “corrugated sheet” of sorts such that the rigidity of the compression limiter is reduced. This variation can be manufactured in a particularly simple fashion because the metallic layer(s) of the metal gasket merely need to be bent.

In another embodiment, the corrugations are realized in the form of thickness variations of at least one metallic layer. In this case, the compression limiter is realized in the form of a thickness profile such that the rigidity of the compression limiter is increased.

In one embodiment of the present invention, the metallic flat gasket is a cylinder head gasket.

According to another aspect of the present invention, an embossing/impressing tool for manufacturing a metallic flat gasket of the above-described type is proposed. In this case, the inventive embossing/impressing tool is realized such that it can provide at least one layer of an inventive flat gasket with a compression limiter of the above-described type. The tool is preferably also provided with structures that punch out through-holes and can press, impress or emboss sealing beads into layers of a metallic flat gasket.

In the drawings, the invention is illustrated in comparison with the state of the art in the form of different embodiments of inventive metal gaskets.

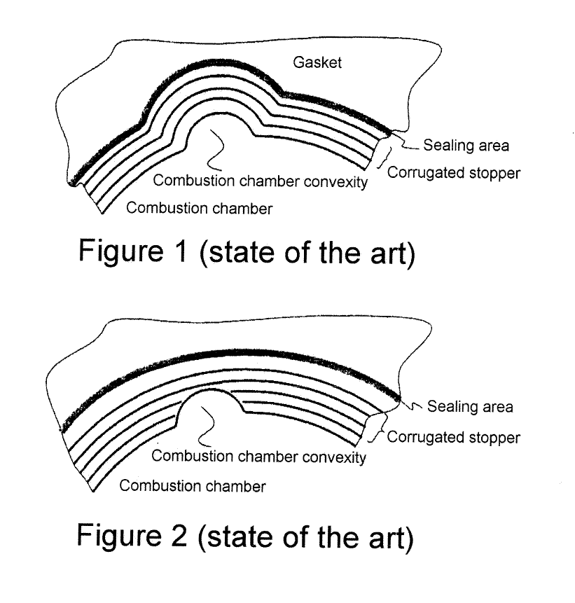

FIGS. 1 and 2 show embodiments of corrugated stoppers known from the state of the art.

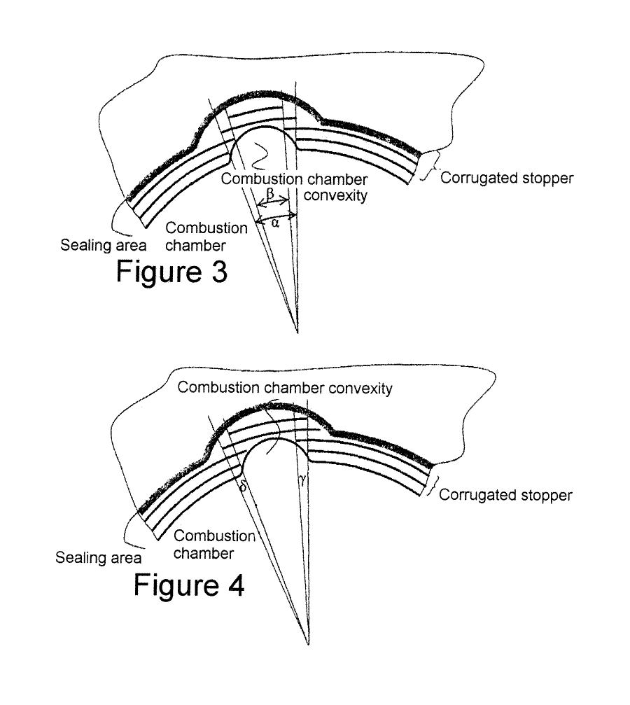

FIGS. 3 and 4 show embodiments of an inventive gasket, in which first and second corrugations of a compression limiter realized in the form of a corrugated stopper mutually overlap and do not mutually overlap.

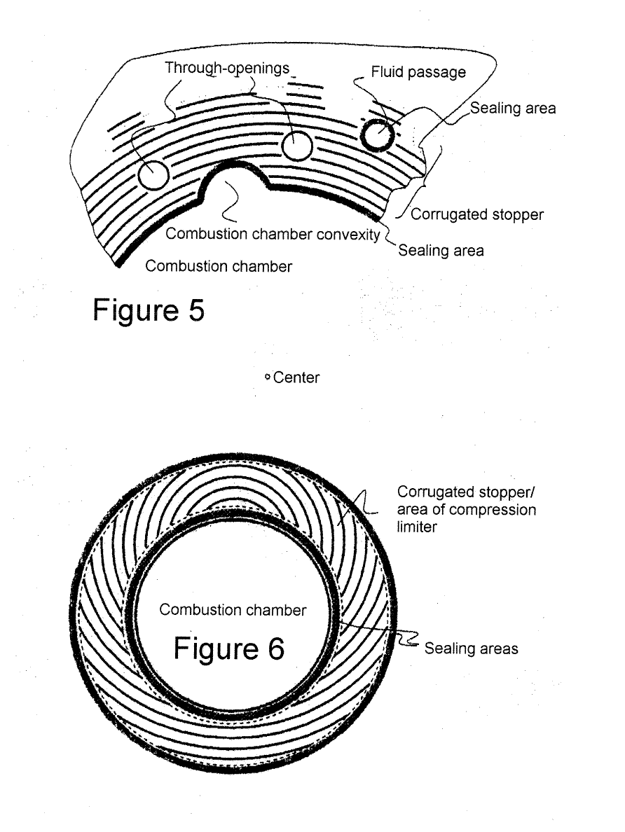

FIGS. 5 and 6 show two embodiments of an inventive gasket, one of which features several through-holes arranged in the region of the compression limiter and the other one of which represents an example of an inventive gasket with an annular compression limiter.

FIG. 1 shows a detail of a conventional flat gasket (cylinder head gasket) with a corrugated stopper (compression limiter) for an internal combustion engine with a lateral combustion chamber convexity. The individual corrugations of the corrugated stopper extend around the combustion chamber convexity such that the manufacture of the tool is much more complicated because the tool cannot be manufactured on a lathe, but rather only on a milling machine with substantially more effort.

FIG. 2 shows a similar detail of another conventional flat gasket (cylinder head gasket) with corrugated stopper (compression limiter, the manufacturing tool of which can be manufactured on a lathe. Analogous to FIG. 1, the internal combustion engine and the cylinder head gasket feature a lateral combustion chamber convexity. The individual corrugations of the corrugated stopper do not extend around the combustion chamber convexity such that the manufacture of the tool is simplified, but the function of the gasket, particularly of the compression limiter, is restricted.

FIG. 3 shows a detail of an inventive flat gasket (cylinder head gasket) with an inventive corrugated stopper (compression limiter). The corrugated stopper is provided with a recess analogous to the cylinder head gasket illustrated in FIG. 2. The individual corrugations of the corrugated stopper do not extend around the combustion chamber convexity, but rather end before they reach the recess. In the area of the recess, the corrugations of the corrugated stopper are continued in the form of additional concentric corrugations that respectively extend in the sectors (a and p), in which the corrugations of the corrugated stopper are interrupted by the combustion chamber convexity. If the corrugations of the corrugated stopper are consecutively numbered from the combustion chamber outward, the first corrugation is continued in the sector a by the third corrugation of the compression limiter or corrugated stopper. The second corrugation is continued in the sector p by the fourth corrugation of the compression limiter/corrugated stopper in exactly the same fashion.

FIG. 4 shows the same detail of an inventive flat gasket (cylinder head gasket) with an inventive corrugated stopper (compression limiter). Similarly to the cylinder head gasket illustrated in FIG. 3, the individual corrugations of the corrugated stopper also supplement one another in this case in order to compensate an impairment of the function of the compression limiter. In the embodiment according to FIG. 4, the individual concentric corrugations respectively overlap in the sectors (γ and δ) In this case, the first corrugation intersects with the third corrugation in the sector δ. The second corrugation intersects with the fourth corrugation in the sector γ in exactly the same fashion. Depending on the selection of the respective sectors α and β or γ and δ, the outside contour of the compression limiter can be realized arbitrarily, for example, in order to optimize the shape of a sealing area extending around the corrugated stopper.

FIG. 5 shows an embodiment of an inventive gasket with a compression limiter featuring seven individual corrugations. In the region of the compression limiter, the gasket features a combustion chamber convexity, as well as through-holes and a fluid passage that is bordered by a sealing area. Each of the seven interrupted corrugations of the corrugated stopper is supplemented by an additional outer corrugation arranged on the corrugated stopper in order to ensure the function thereof. In addition, the dotted line indicates an optimized outside contour of a corrugated stopper that essentially preserves the surface of the deformation limiter with the smoothest outside contour possible.

FIG. 6 merely illustrates the principle of the compression limiter according to the present invention in a borderline case. In FIG. 6, an arbitrary surface (in this case a circular ring) is realized in the form of a corrugated stopper or compression limiter by means of a number of concentric corrugations. In this case, the concentric corrugations of the corrugated stopper completely fill out the annular surface of the corrugated stopper similar to a circular hatching, wherein the concentric corrugations are not concentric to the area of the compression limiter. It should be clear that any arbitrary surface, in which a compression limiter should extend, can be filled out with a corrugated stopper of the type shown. This elucidates that the present invention is likewise suitable for arbitrarily shaped flat gaskets. It should also be clear that cylinder head gaskets with several combustion chamber openings can also be manufactured with an inventive corrugated stopper or compression limiter. In this case, the principle of the present invention can be applied separately to each compression limiter around each combustion chamber opening.

The gaskets illustrated in FIGS. 3 to 6 can be manufactured with a tool that can largely be manufactured on a lathe.

The tool for manufacturing an inventive gasket may, in principle, be manufactured by turning a total number of corrugations (n+x) into the tool, wherein n corrugations are required for maintaining the stopper pressure. In the region of a constriction (a convexity, a through-hole or the like), a number x of corrugations are removed in a sector and a number x of other corrugations remain. The number of corrugations is reduced to n in the remaining outer area. In the transition areas between corrugations that are removed on the inside and corrugations that remain on the outside, the inner and the outer corrugations may overlap by a width of up to n corrugations in order to also preserve the stopper pressure in the transition area.

1. A metallic flat gasket with at least one metallic layer, wherein the metallic gasket includes at least one sealing area and a compression limiting area that is in the form of a corrugated profile in at least one layer of the metallic gasket, wherein the corrugated profile is formed in the area of the compression limiter by several corrugations that extend on concentric circular lines, wherein
at least one first corrugation extends along at least one predetermined arc of a circle and does not extend in at least one predetermined sector of a circle, and in that the flat gasket features at least one second interrupted corrugation that extends concentric to the first corrugation, has a different radius than the first corrugation and extends at least in the sector of a circle, in which the first corrugation does not extend, and does not extend in at least one sector of a circle, in which the first corrugation extends.

2. The metallic flat gasket according to claim 1, including at least one through-opening that is enclosed by the sealing area and the compression limiting area.

3. The metallic flat gasket according to claim 2, wherein the through-opening is provided with convexities and the area of the compression limiter is indented.

4. The metallic flat gasket according to claim 1, including through-holes are provided in the area of the compression limiter.

5. The metallic flat gasket according to claim 1, wherein the same number of corrugations extend around the center of the through-opening to be sealed in a circular or arc-shaped fashion radially from this the center of the through opening.

6. The metallic flat gasket according to claim 1, wherein the first and the second corrugations overlap one another in a sector by at least half the width of the compression limiting area.

7. The metallic flat gasket according to claim 1, wherein the height of the corrugations gradually decreases toward their ends.

8. The metallic flat gasket according to claim 1, wherein the corrugations are formed by beads of the at least one metallic layer.

9. The metallic flat gasket according to claim 1, wherein the corrugations are formed by thickness variations of the at least one metallic layer.

10. The metallic flat gasket according to claim 1, wherein the metallic flat gasket is a cylinder head gasket.

11. An impressing/embossing tool for manufacturing a metallic flat gasket according to claim 1.
